(19) United States
(12) Patent Application Publication
(10) Pub. No.: US 2012/0221587 A1
(43) Pub. Date: Aug. 30, 2012

(54) Method for Generating Search Results and System for Information Search

(75) Inventor: Hua Chen, Hangzhou (CN)

(73) Assignee: ALIBABA GROUP HOLDING LIMITED, Grand Cayman (KY)

(21) Appl. No.: 12/922,495

(22) PCT Filed: Apr. 29, 2010
(86) PCT No.: PCT/IB10/02011

§ 371 Date: Sep. 14, 2010

(30) Foreign Application Priority Data
Nov. 4, 2009 (CN) 200910209360.1

(51) Int. Cl. G06F 17/30

(52) U.S. Cl. 707/758; 707/E17.014

(57) ABSTRACT

A method for generating search results and a system for searching information are provided. In one aspect, a method for generating search results includes receiving a search keyword A by an information search system. The information search system conducts a search process and retrieves words related to the keyword A. In a first section of a webpage, information corresponding to the keyword A is displayed, and in a second section of the webpage, keyword A and at least one related word are displayed. Keyword A is highlighted. When the user selects a word related to keyword A, such as A1, the system will display the information corresponding to A1 in the first section, maintain the information displayed in the second section, and highlight the related word A1 in the second section. The proposed techniques of the present application can simplify the search operations, and the user can freely arrange the search results of the search keyword and its related words or phrases, thus speeding up the retrieval of corresponding search results. At the same time, with respect to a search system, the disclosed techniques can effectively reduce the number of search requests; thereby lessen the load on the search server.

### CROSS REFERENCE TO RELATED PATENT APPLICATIONS

This application is a national stage application of an international patent application PCT/IB2010/002011, filed Apr. 29, 2010, entitled “Method for Generating Search Results and System for Information Search”, which claims priority from Chinese Patent Application No. 200910209360.1, filed Nov. 4, 2009, entitled “METHOD FOR GENERATING SEARCH RESULTS AND SYSTEM FOR INFORMATION SEARCH,” which applications are hereby incorporated in their entirety by reference.

### TECHNICAL FIELD

The present disclosure relates to the field of computer technology and, more specifically, to a method for generating search results and a system for searching information.

### BACKGROUND OF THE DISCLOSURE

An information search system is a system that provides users with information retrieval, such as the commonly used search engine on the Internet. Search engines have become one of the invaluable support tools for users who browse the Internet. From a user's perspective, a search engine typically provides an interface that includes a search box. When the user enters a keyword in the search box, and after submitting the keyword to the search engine through the browser, the search engine will return information that corresponds to the user's keyword.

In a real situation, how the user selects the keyword is rather subjective. Thus, when the user enters a keyword that does not accurately reflects the user's intent, the user will not receive a satisfactory search result. To solve this problem, many search engines provide “related search” functionality. The basic implementation approach is as follows: after the search engine receives the keyword entered by the user, it will follow a predefined calculation method; search for a predefined number of related words; and in the process of returning information matching the keyword, the search engine will also provide related words to the user. When the user clicks on these related words, the search engine will use the clicked words as the keywords, and start another search process.

Through research into this modern technology, it was discovered that during actual search using the related searches, many users would just try clicking any of the related words, and when the user is not satisfied with the search results, the user might go back to the search results from the original keyword, or use the other related words of the original keyword to start another search process. But at this point, the user would discover that the original keyword (or its related words) is not in the list of related words of the current keyword, and the user has to re-enter the original keyword to restart the search process. This decreases the search efficiency, and the user's repeated search actions create a burden on the search server. Although the user can use the “back” function of the browser to achieve the same results, the user could have browsed through many web pages while going through the search results and could have looked up the related words twice. As a result, the user has to use the “back” function many times to find the initial search results, which is not only tedious but inefficient as well.

### SUMMARY OF THE DISCLOSURE

To solve the technical problems mentioned above, the sample implementations will provide a method for generating search results and a system for searching information, in order to simplify the search steps the user takes, to increase search efficiency, and to reduce the load of the search server. The proposed technology is as follows:

In one aspect, a method for generating search results includes: receiving, by an information search system, a keyword for search; conducting a search using the keyword to obtain words and phrases related to the keyword; displaying information corresponding to the keyword in a first section of a webpage; displaying the keyword and at least one word or phrase related to the keyword in a second section of the webpage; and after one of the words and phrases related to the keyword is selected, displaying information corresponding to the selected word or phrase in the first section of the webpage while maintaining information displayed in the second section of the webpage.

In various embodiments, the keyword in the second section of the webpage may be highlighted. After the selected word or phrase is selected, the selected word or phrase in the second section of the webpage may be highlighted. The keyword and the words and phrases that are related to the keyword and obtained from the search may be displayed. The keyword and the words and phrases related to the keyword may be displayed in a tree structure, where the words and phrases related to the keyword are braches off of the keyword in the tree structure.

The act of displaying the keyword and at least one word or phrase related to the keyword in a second section of the webpage may include: displaying the keyword in the second section of the webpage; when the keyword displayed in the second section is selected, performing computation to obtain words and phrases related to the keyword; and displaying in the second section the keyword and at least one of the retrieved words and phrases in a tree structure. The act of displaying in the second section at least one of the words and phrases related to the selected word or phrase may include creating a menu of the selected word or phrase, the menu displaying the at least one of the words and phrases related to the selected word or phrase. Alternatively, the act of displaying in the second section at least one of the words and phrases related to the selected word or phrase may include displaying the selected word or phrase and the words and phrases related to the selected word or phrase in a tree structure, the words and phrases related to the selected word or phrase being branches off of the selected word or phrase in the tree structure.

After one of the words and phrases related to the keyword is selected, the method may further include: performing computation to obtain words and phrases related to the selected word or phrase; and displaying in the second section at least one of the words and phrases related to the selected word or phrase.

The selected word or phrase may be an expanded related word or phrase of the keyword. The information corresponding to the selected word or phrase may be a subset of the information corresponding to the keyword.

In another aspect, an information search system includes a search module, a first section processing module, and a second section processing module. The search module receives a keyword for search and conducts a search using the keyword to obtain words and phrases related to the keyword. The first section processing module displays information corresponding to the keyword in a first section of a webpage, the first section processing module displaying in the first section a word or phrase that is related to the keyword and selected by a user. The second section processing module displays the keyword and at least one word or phrase related to the keyword in a second section of the webpage, the second section processing module maintaining information displayed in the second section after the selected word or phrase is selected by the user.

The second section processing module may display the keyword and the words and phrases that are related to the keyword and obtained from the search. The second section processing module may display the keyword and the words and phrases related to the keyword in a tree structure, where the words and phrases related to the keyword are braches off of the keyword in the tree structure.

The second section processing module may include: a keyword display sub-module that displays the keyword in the second section of the webpage; a first related words and phrases computation sub-module that performs computation to obtain words and phrases related to the keyword when the keyword displayed in the second section is selected; and a first related words and phrases display sub-module that displays in a tree structure the keyword and at least one word or phrase related to the keyword, the at least one word or phrase related to the keyword branching off of the keyword in the tree structure.

The second section processing module may further include: a second related words and phrases computation sub-module that performs computation to obtain words and phrases related to the selected word or phrase when the selected word or phrase is selected; and a second related words and phrases display sub-module that displays in the second section of the webpage at least one word or phrase related to the selected word or phrase.

The second related words and phrases display sub-module may create an expandable menu for the selected word or phrase and displays at least one word or phrase related to the selected word or phrase in the expandable menu. The second related words and phrases display sub-module may display the selected word or phrase and the words and phrases related to the selected word or phrase in a tree structure, where the words and phrases related to the selected word or phrase are branches off of the selected word or phrase in the tree structure. The selected word or phrase may be an expanded related word or phrase of the keyword. The information corresponding to the selected word or phrase may be a subset of the information corresponding to the keyword.

By implementing the proposed technology, the search operations are simplified, and the user can freely arrange the search results of the search keyword and its related words or phrases, thus speeding up the retrieval of matching search results and increasing the search efficiency. At the same time, from the system's perspective, the number of search requests is effectively reduced, which will lessen the load on the search server.

### BRIEF DESCRIPTION OF THE DRAWINGS

In order to explain more clearly the implementation example or the proposed technology, below is a simple description of the drawings used for the implementation example or the proposed technology. As can be clearly seen, the drawings are only some of the exemplary implementations. To someone who does not have knowledge of the technology, the follow drawings may aid the understanding of the technology.

FIG. 1 shows a flow diagram of a process for generating search results in accordance with the present disclosure.

FIG. 2 shows a schematic diagram of the generated search results in accordance with the present disclosure.

FIG. 3 shows another schematic diagram of the generated search results in accordance with the present disclosure.

FIG. 4 shows yet another schematic diagram of the generated search results in accordance with the present disclosure.

FIG. 5 shows a tree structure of a keyword and its related words in accordance with the present disclosure.

FIG. 6 shows a block diagram of an information search system in accordance with the present disclosure.

FIG. 7 shows a block diagram of a module in accordance with the present disclosure.

### DETAILED DESCRIPTION OF THE PREFERRED EMBODIMENT

Through research into modern technology, the causes of the above-mentioned technical problems have been identified and will be described below.

Currently, with respect to searches, there are many conventional methods for handling the computation for related words or phrases. Yet, the computation for or phrases words using these conventional methods does not guarantee that the “relation” of the words and phrases are symmetrical and transmittable. For example, when keyword A is entered, the system can compute that the related words/phrases include A1, A2, A3, and so on, and display these related words or phrases to a user. Lack of symmetry refers to the following: if the user enters keyword A1, the related words or phrases computed by the system may not necessarily include A. Inability to be transmitted refers to the following: if the user enters keyword A1, the related words/phrases computed by the system may not necessarily include A2 or A3.

This can especially be seen in the actual search process. Due to limitation in the available space for display in a given page, after computing one group of related words or phrases, the system will initially follow predefined rules in sorting the related words/phrases, and then display the first few related words or phrases in the sorted queue to the users. This tends to reduce the possibility of the user seeing the original keyword or other related words or phrases of the original keyword. To further explain using the example above, when the user enters the keyword A1, although the system has computed that the related words or phrases of A1 include A, A2, or A3, due to the lower sorted order of one or more of these words, it is possible that any of these related words or phrases will not be displayed to the user.

Based on current methods of searching for related words or phrases, once the user clicks on a related word/phrase, the system will use that related word/phrase as the keyword and start another search process. Again, to further explain using the example above, after the user used keyword A to start the search process, based on the related words or phrases proposed by the system, the user selects A1 and starts another search process. At this time, if the user is not satisfied with the search results for A1 and wants to go back to the search results of keyword A, the user should re-enter keyword A (supposing that the search results for A1 computed by the system do not include A) to start the search process. This not only decreases search efficiency, but also causes hassle to the user.

On the other hand, the user might not remember the specific forms of A2, A3 or other related words or phrases of A. Therefore, after the user sees the search results of keyword A1 and views the other search results of keyword A, the user will need to re-enter keyword A to start the search process, then select the other related words or phrases of A. In practice, this is very cumbersome and the repeated search operations also create a burden on the search server.

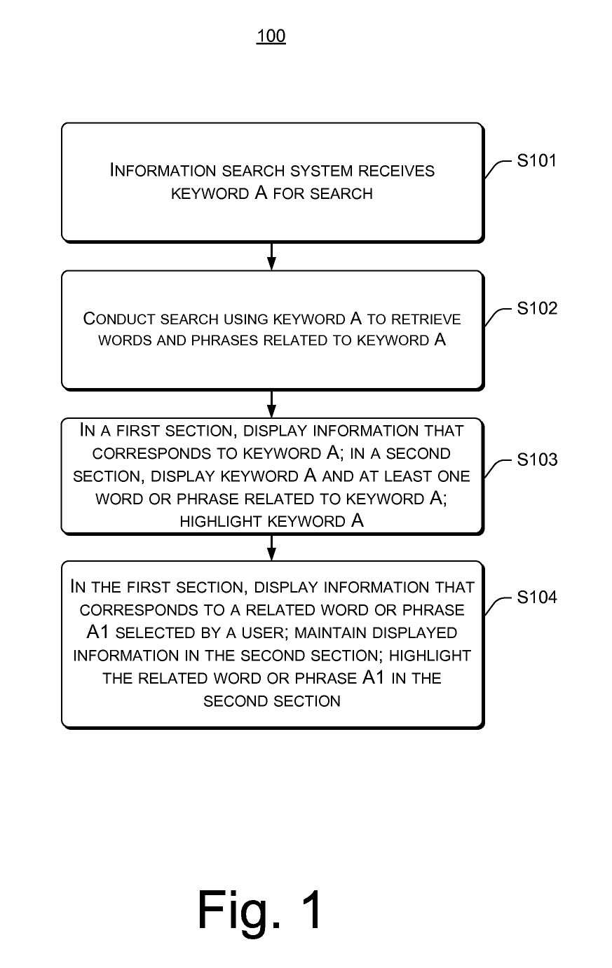

To solve the above-mentioned problems, the present disclosure proposes a method for generating search results. Referring to FIG. 1, a process 100 for generating search results includes the following steps:
S101: An information search system receives search keyword A.
S102: Using keyword A, the information search system conducts a search process and retrieve words and phrases related to keyword A.
S103: In a first section of a webpage, information corresponding to keyword A is displayed. In a second section of the webpage, keyword A and at least one word or phrase related to keyword A are displayed. Keyword A is also highlighted.
S104: When the user selects any word or phrase related to keyword A, such as A1, information corresponding to the related word or phrase A1 is displayed in the first section. The content displayed in the second region is maintained. The related word or phrase A1 in the second section is highlighted.

The method of computing related words or phrases based on a search keyword can be implemented using different approaches that are part of existing technologies. For example, one can use the original keyword as the root word or as a prefix or suffix to expand the search, or check the user's search history to find words that have a higher search frequency than the original keyword. To make the user's selection process easier, the system will even follow pre-defined steps, and will select the words or phrases most related to the original keyword (e.g., 5 words or 10 words) and display them as output. When it comes to the computation method and sorting rules, the definition of “degree of correlation” (relatedness) is not exactly the same, and in the implementation example, it is not necessary to pay close attention to the detailed computation method and sorting rules for the related words or phrases. As for related search results that are based on any computation method and sorting rule, the proposed technology of the present disclosure can be used to achieve corresponding technical results.

Based on existing technologies, the method used to carry out related searches consists of the following: after the user selects a related word or phrase of keyword A, such as A1, the system will use A1 as the keyword to start a new search process, and at the same time re-compute for the related words or phrases of A1. At this point, the user may be unable to find the word A in the search results of A1. According to one embodiment of the present disclosure, after the user selects a related word or phrase of keyword A, such as A1, the system will only change the corresponding search results (first section), and will retain the originally displayed keyword A and its search results. The system will only highlight A1, which indicates that A1 is currently the search keyword. Highlighting the current search keyword makes it stand out, such as by underlining the keyword or using bold font, to highlight the keyword. In this way, when the user wants to go back to the search results of A, or if the user wants to look up the search results of the other related words or phrases, the user can conveniently make the switch without changing the current display page. Additionally, since most browsers have localized cache, when the user changes the keyword back to the previous search results without changing the display page, the system will not resubmit the search request to a search server, thus minimizing the load on the search server.

Below are some specific examples, which will further explain methods for generating search results, as proposed in the present disclosure.

### First Exemplary Embodiment

If the user enters “ [symbol] ” (meaning “Westlake” in English) as the keyword for the search, the system will use pre-defined computation methods and sorting rules to retrieve five words and/or phrases that have the highest degree of correlation to “ [symbol] [symbol] ”,namely: “ [symbol] ” (meaning “Map of Westlake” in English), “ [symbol] ”(meaning “Westlake Poetry” in English), “ [symbol] ” (meaning “Beautiful Scenery of Westlake” in English), “ [symbol] ” (meaning “10 Scenes of Westlake” in English), and “ [symbol] ” (meaning “Westlake Entrance Ticket” in English). In executing the search request for “ [symbol] ” (“Westlake”), the system will provide two types of display:
1) In a display section for search results, display the search results that correspond to “ [symbol] ” (“Westlake”); and
2) In a display section for related words and phrases, display “ [symbol] ” (“Westlake”) and the five related words or phrases as shown above.

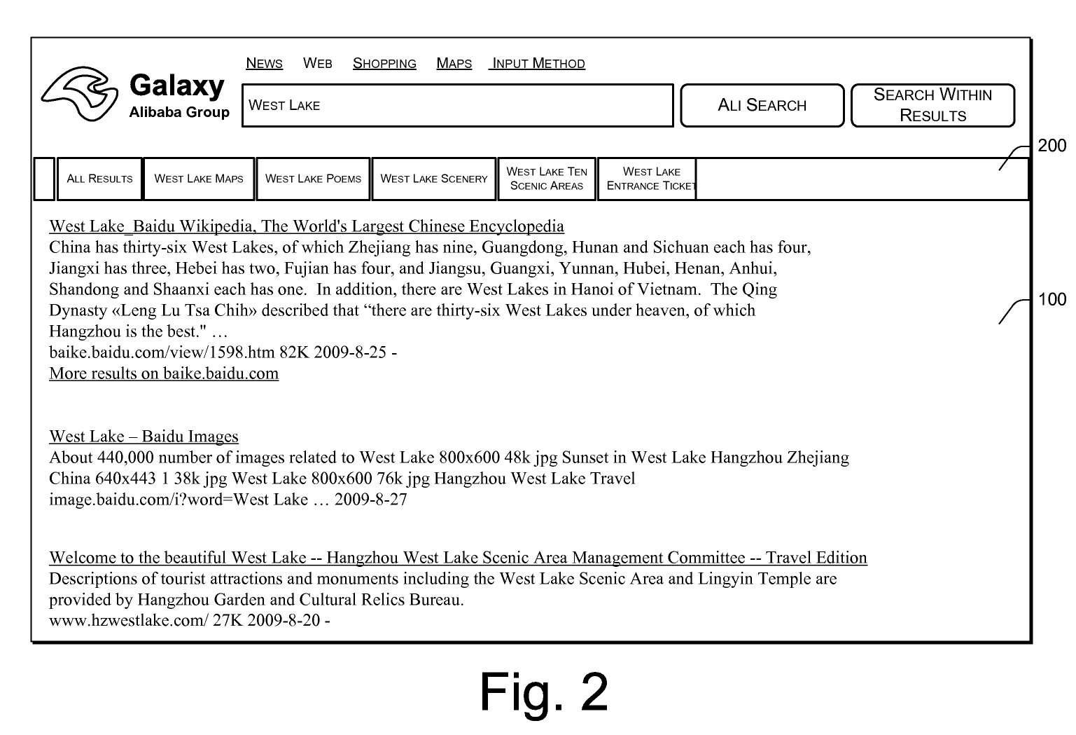

As shown in FIG. 2, section 100 of a webpage is the display section for search results (with FIG. 2 only used for illustrative purpose and not including all the search results), and section 200 is the display section of the related words/phrases. Take note that, the tab “ [symbol] ” (meaning “All Results” in English) displayed in section 200 is with respect to the keyword “ [symbol] ” (“Westlake”), and the search box on top of section 200 displays the current search keyword “ [symbol] ” (“Westlake”). Therefore, the basic function of the tab “ [symbol] ” (“All Results”) is to display “ [symbol] [symbol] ”(“Westlake”). Of course, those ordinarily skilled in the art can change the format of the display, such as using the tab label “ [symbol] ” (meaning “Entire Results” in English) instead, for example. It shall be understood that the present disclosure is not limited to the examples shown herein.

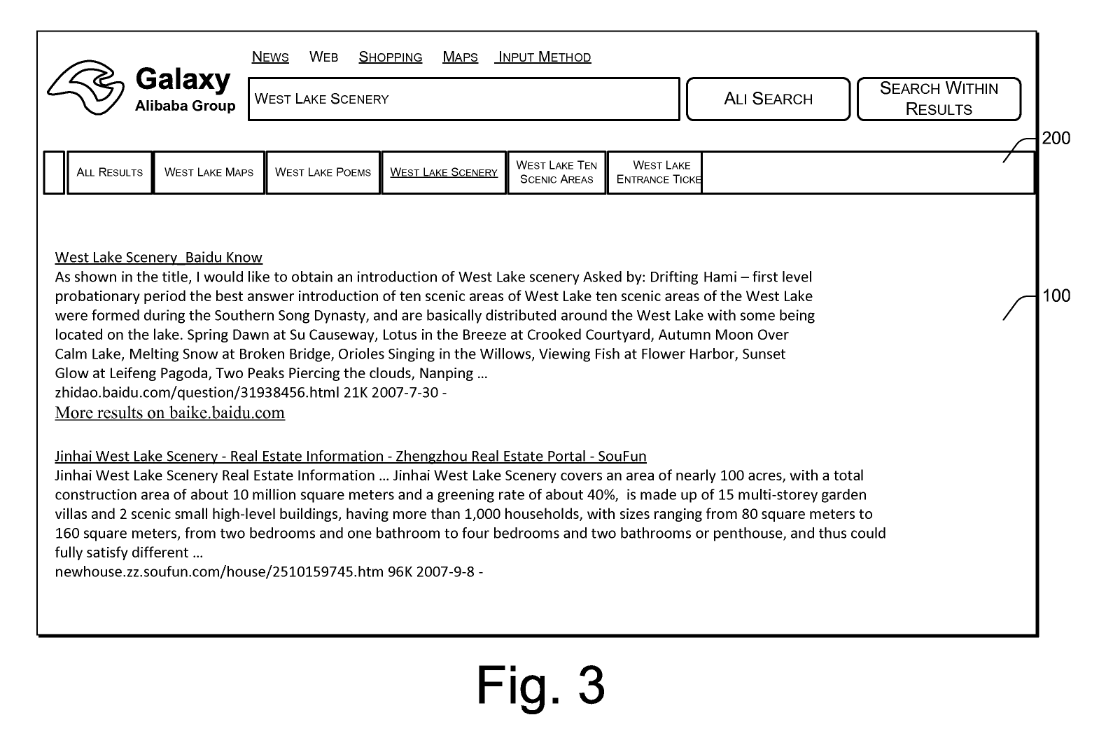

In this exemplary embodiment, the section that displays the related words/phrases is located above the search results display section. In the search results display section, the keyword and each related word or phrase are all displayed in tab format. As can be seen in FIG. 2, in the related words/phrases section 200, the “ [symbol] [symbol] ∞ (“All Results”) tab is highlighted. The appearance of this tab is different from the other tabs, which means that it contains the search results of the original keyword “ [symbol] ” (“Westlake”). When the user wants to view the search results of a given related word or phrase, the user can click on the tab corresponding to that related word or phrase. For example, when the user clicks on the tab “ [symbol] ” (“Beautiful Scenery of Westlake”), the system will generate the search results as shown in FIG. 3.

As shown in FIG. 3, the displayed content of the search results display section 100 is updated to include search results for “ [symbol] ” (“Beautiful Scenery of Westlake”), but the words and phrases in the related words/phrases display section 200 are not changed. The only difference is that the “ [symbol] ” (“Beautiful Scenery of Westlake”) tab is highlighted (at the same time, the “ [symbol] ” (“All Results”) tab is not highlighted), indicating that the highlighted tab contains the search results of “ [symbol] ” (“Beautiful Scenery of Westlake”). At this point, if the user wants to go back to the search results of “ [symbol] ” (“Westlake”), or if the user wants to go to the search results of “ [symbol] ” (“Map of Westlake”), “ [symbol] ” (“Westlake Poetry”) and the other related words or phrases, the user can do so by clicking on the corresponding tabs, conveniently switching among the search results of the keyword and its related words and phrases.

One noteworthy feature is that the system can save the search results of, for example, “ [symbol] ” (“Beautiful Scenery of Westlake”), and eventually save them on the server side or on the client side. In this way, when the user selects the other related words and phrases, but needs to view the search results of “ [symbol] ” (“Beautiful Scenery of Westlake”) again, the previously saved search results can be displayed, thus avoiding another search process.

### Second Exemplary Embodiment

The difference between the first exemplary embodiment and the second exemplary embodiment are as follows: After the user selects a related word or phrase, the information displayed in the section that displays the related words/phrases is maintained so the user can conveniently switch between the search results of the original keyword and that of its related words and phrases. In certain cases, the user may desire to view the related words or phrases of a word/phrases related to the original keyword, so that the user can start another search process. To enable such situation, the second exemplary embodiment utilizes the techniques described above with respect to the first exemplary embodiment as the basis for suggesting the improvements described below.

After the user selects the related word or phrase A1 of the keyword A, the system will retrieve words and phrases related to the word or phrase A1. Since the original results are retained in the display section 200, the system will further display at least one related word or phrase of A1 in the related words/phrases display section 200.

To further explain using an earlier example, when the user clicks on the “ [symbol] [symbol] ” (”Beautiful Scenery of Westlake“) tab in the search results in FIG. 2, the system will do the following:
1) Change the content of the search results display section 100 to the search results of “ [symbol] ” (“Beautiful Scenery of Westlake”).
2) Highlight the tab of “ [symbol] ” (“Beautiful Scenery of Westlake”).

Additionally, the system will retrieve words and phrases related to “ [symbol] ” (“Beautiful Scenery of Westlake”). The particular computation methods and sorting rules employed to make this happen are not considered here. Supposing that the four words/phrases with the highest degree of correlation to “ [symbol] ” (“Beautiful Scenery of Westlake”) are “ [symbol] ” (meaning “Pictures of Beautiful Westlake Scenery” in English), “ [symbol] ” (meaning “10 Beautiful Scenes of Westlake” in English), “ [symbol] ” (meaning “Introduction of the Beautiful Westlake Scenery”, and “ [symbol] ” (meaning “Beautiful Westlake Scenery in March” in English).

In the interest of brevity, we will refer to “ [symbol] ” (“Map of Westlake”), “ [symbol] ” (“Westlake Poetry”), “ [symbol] ” (“Beautiful Scenery of Westlake”), “ [symbol] [symbol] ” (“10 Scenes of Westlake”), and “ [symbol] ” (“Westlake Entrance Ticket”) as the first level related words/phrases, and refer to the four words/phrases related to “ [symbol] [symbol] ” (“Beautiful Scenery of Westlake”) as the second level related words/phrases. Since the specific computation methods for the related words and phrases may be different, it is possible that the second level related word/phrase (or above the second level) is the keyword itself The implementation of the present disclosure has nothing to do with the specific computation methods, so the “first level” and “second level” mentioned here only refer to the relationship of one word or phrase to another.

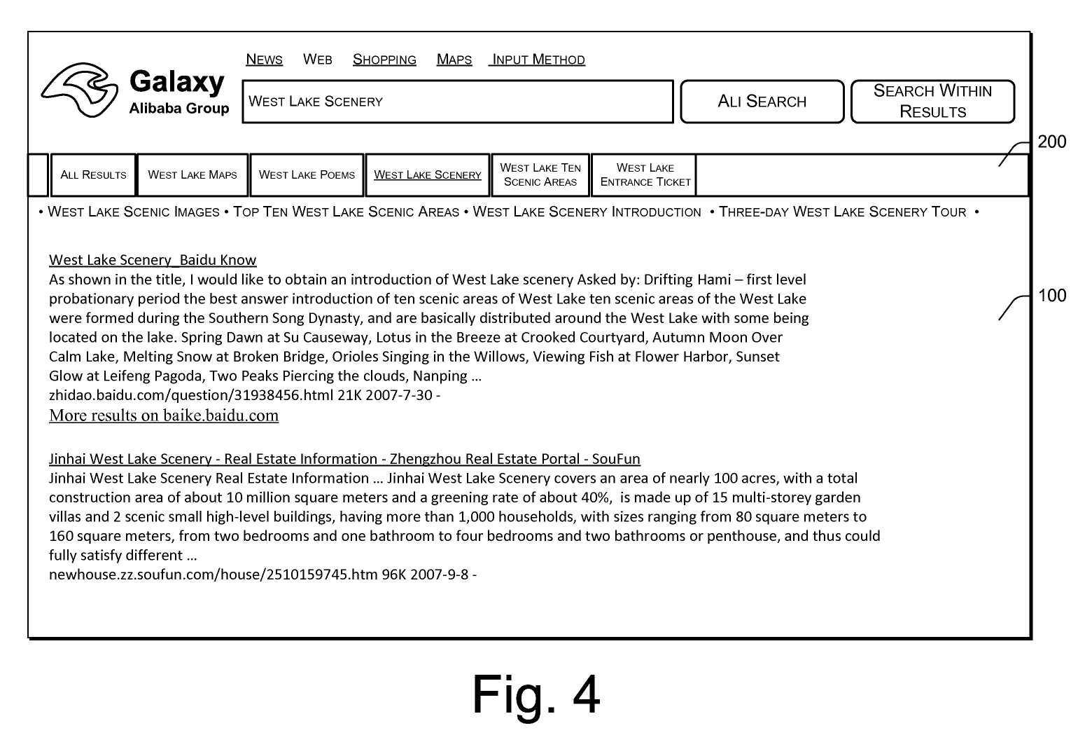

After the user selects the first level related phrase “ [symbol] ” (“Beautiful Scenery of Westlake”), the system will display the four related words/phrases of “ [symbol] [symbol] ” (“Beautiful Scenery of Westlake”) in the related words/phrases display section 200. At the same time, “ [symbol] ” (“Beautiful Scenery of Westlake”) should be differentiated from the other first level related words/phrases (e.g. “ [symbol] ” (“Map of Westlake”), “ [symbol] ” (“Westlake Poetry”), etc.) of “ [symbol] ” (“Westlake”). One method is to use an expanded display. For example, using the “ [symbol] ” (“Beautiful Scenery of Westlake”) tab as the base, the system will create an expandable menu, and display the four related words/phrases of “ [symbol] ” (”Beautiful Scenery of Westlake“), as shown in FIG. 4.

Furthermore, the user can directly select any of the second level related words or phrases and start another search. Correspondingly, the system will display the corresponding search results of the selected second level related word or phrase in the search results display section 100. At this time, the content of the related words/phrases display section 200 include the following: the original keyword, all the first level related words and phrases of the original keyword, and the words and phrases related to “ [symbol] ” (“Beautiful Scenery of Westlake”) in an expandable menu format. The second level word or phrase that the user selected is also highlighted, so as to differentiate it from the other second level words and phrases.

One noteworthy feature is that the system can save the search results of, for example, “ [symbol] ” (“Beautiful Scenery of Westlake”) either on the server side or on the client side. In this way, when the user selects the other first level related words/phrases, and then selects “ [symbol] ” (“Beautiful Scenery of Westlake”) again, the system can directly display the previously saved search results, thus preventing a re-computation of the search results.

The second exemplary embodiment takes into account that some users would request related searches twice, and includes some improvements over the first exemplary embodiment. This will enable the users to conveniently switch among the search results of the original keyword, first level related words and phrases, and second level related words and phrases, without changing the current display screen.

### Third Exemplary Embodiment

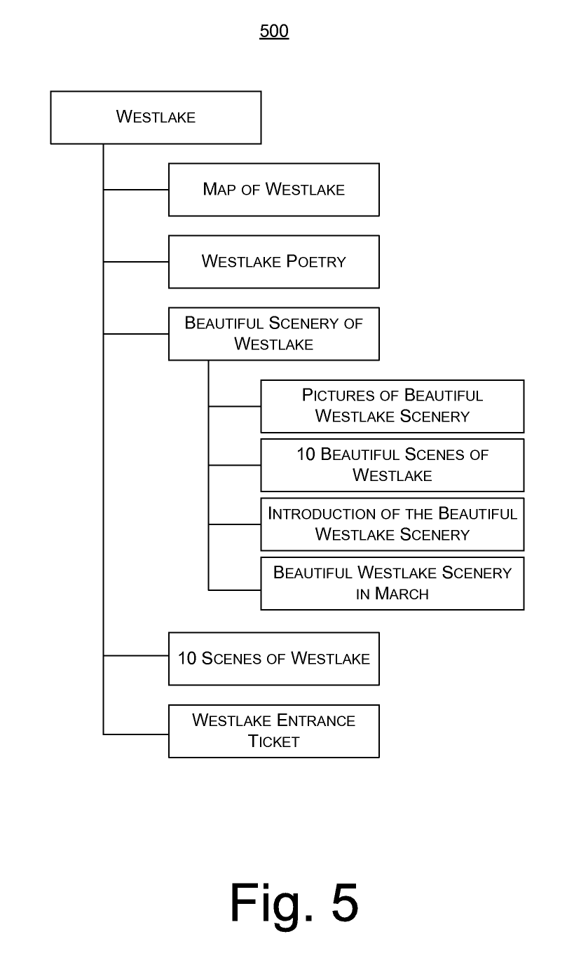

In the examples above, the original keyword and its related words and phrases are displayed at the same time. Based on the second exemplary embodiment, the relationship between words and phrases can be established in a hierarchical way, with the keyword and its related words and phrases displayed in a tree structure 500 as shown in FIG. 5.

Referring to FIG. 5, the original keyword “ [symbol] ” (“Westlake”) is the root node of the tree structure. The first level related words/phrases “ [symbol] ” (“Map of Westlake”), “ [symbol] ” (“Westlake Poetry”), “ [symbol] ” (“Beautiful Scenery of Westlake”), “ [symbol] ” (“10 Scenes of Westlake”), and “ [symbol] ” (“Westlake Entrance Ticket”) are the branch nodes of the root node “ [symbol] ” (“Westlake”). The second level related words/phrases “ [symbol] ” (“Pictures of Beautiful Westlake Scenery”), “ [symbol] ” (“10 Beautiful Scenes of Westlake”), “ [symbol] ” (“Introduction of the Beautiful Westlake Scenery”, and “ [symbol] ” (“Beautiful Westlake Scenery in March”) are the branch nodes of “ [symbol] ” (“Beautiful Scenery of Westlake”).

As shown, such structure can more clearly show the relationship of the words and phrases to each other, and the user can conveniently switch among the search results of the original keyword, first level keyword, and second level keyword. If needed, the user can even conduct third level, fourth level . . . n^{th} level searches, where the computation of the related words and phrases for each level can be shown as branch nodes and inserted into the original tree structure.

Based on the unique features of a tree structure, in an actual display screen, in one embodiment the related words/phrases display section can be placed on the left side of the search results display section. Based on actual search requests, the user can expand or collapse any branch. When the user first uses the original keyword A to start the search process, the related words/phrases display section will only display the related word A. When the user selects the related word A by clicking it for example, it means the user wants to do a search of the related words, so the system will begin computation to retrieve the related words and phrase, and then retrieve the related words of A, for example A1-A5. At the same time, it will display A1-A5 as branches of A in the related words/phrases display section. As for A1-A5, we can use the same trigger mechanism in computing for the related words and phrases. The advantage of doing so is to prevent the system from unnecessarily computing for the related words and phrases when the user has no search requests, thus lessening the burden on the search server.

Similar to the first and second exemplary embodiments, after the user has selected a branch node, the system can also save the corresponding search results of the branch node and the computation results for the related words/phrases, to prevent the system from initiating new search and computation processes.

It is important to emphasize that in the examples above, there are no restrictions on what specific computation methods to be used for the related words and phrases. However, by combining the methods for generating search results, the best computation method for the related words and phrases may be the expanded computation method. Using the expanded computation method in computing for the related words and phrases, the results include the original keyword and the computed related words and phrases, which are called the expanded related words/phrases. For example, the related words/phrases of “ [symbol] ” (“Westlake”)—“ [symbol] ” (“Map of Westlake”), “ [symbol] ” (“Westlake Poetry”), “ [symbol] ” (“Beautiful Scenery of Westlake”), “ [symbol] ” (“10 Scenes of Westlake”), and “ [symbol] ” (“Westlake Entrance Ticket”)—are all expanded related words of “ [symbol] ” (“Westlake”), while “ [symbol] [symbol] ” (meaning “Hangzhou” in English) is not part of the expanded related words/phrases of “ [symbol] ” (“Westlake”).

In a computation process, the system may use the original keyword as the root word or as the prefix or suffix, and expand it to include the new related words and phrases. Alternatively, the system may first use a word separation technique to analyze the original keyword, add new parts and then reassemble to obtain the new related words/phrases, e.g., “ [symbol] ” (“Beautiful Scenery of Westlake”)→“ [symbol] [symbol] ” (“10 Beautiful Scenes of Westlake”).

Correspondingly, for the search results, the collection of information corresponding to the expanded related words/phrases is a subset of the collection of information corresponding to the keyword. In other words, whenever the user selects the related words/phrases obtained from the expanded computation method, the user is looking at the more detailed search of the search results. This can significantly reduce the amount of data that needs to be processed for searching the related words and phrases, thus increasing the speed of the search process. With respect to the tree structure, the information corresponding to each branch node is the more detailed information of its parent node. This can prevent nodes from repetitively appearing in the tree structure, and thus make the tree structure more optimized

Of course, during actual application, various ways may be used to implement the expanded computation method. For example, when computing for the first level related words and phrases, any computation method may be used to enable users to see a more complete picture of the first level related words/phrases. Thereafter, when computing for the second level related words and phrases, the expanded computation method may be used to achieve the effects of the detailed search method.

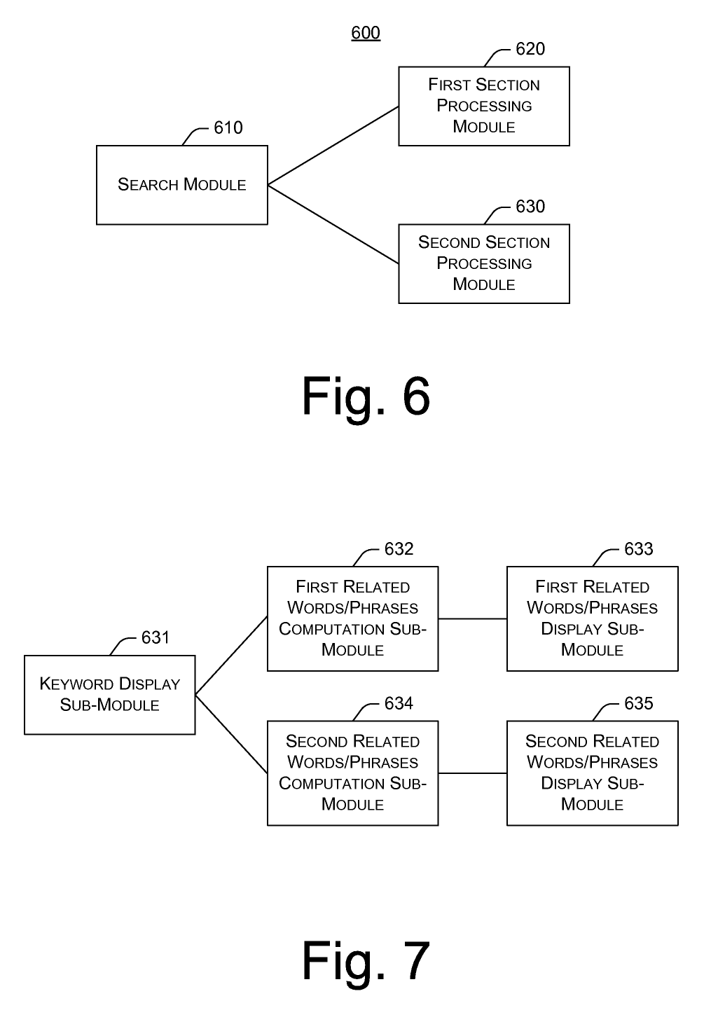

In view of the above-mentioned implementation techniques, the present disclosure further proposes an information search system 600, as shown in FIG. 6. The information search system 600 includes: a search module 610 that receives a keyword A, a first section processing module 620 that displays information corresponding to the keyword A in a first section of a webpage, and a second section processing module 630 that displays the keyword A and at least one related word or phrase, with the keyword A highlighted, in a second section of the webpage.

When the user selects any of the related words or phrases of keyword A, such as A1, the first section processing module 620 displays information corresponding to the related word or phrase A1 in the first section of the webpage. The second section processing module 630 maintains the information displayed in the second section and highlights the related word or phrase A1 in the second section of the webpage.

In the process, the second section processing module 630 displays the keyword A as well as words and phrase related to keyword A. The second section processing module 630 can also display both keyword A and the words and phrases related to keyword A in a tree structure. In the tree structure, the related words and phrases for keyword A are shown as branches of keyword A.

FIG. 7 shows an embodiment of the structure of the second section processing module 630. As shown in FIG. 7, the second section processing module 630 includes: a keyword display sub-module 631 that displays the keyword A in the second section of the webpage, a first related words/phrases computation sub-module 632 that performs computation to retrieve the related words and phrase of keyword A when the user selects keyword A in the second section, a first related words/phrases display sub-module 633 that displays at least one related word or phrase of keyword A as a branch in the second section, a second related words/phrases computation sub-module 634 that that performs computation to retrieve the related words and phrase of a related word or phrase A1 of keyword A when the user selects the word or phrase A1, and a second related words/phrases display sub-module 635 that displays at least one related word or phrase of A1 in the second section of the webpage.

The second related words/phrases display sub-module 635, which is the second sub-module for displaying related words and phrases, can be used to create the expandable menu of A1, and display at least one related word or phrase of A1 in the expandable menu. It can also be used to display the related words and phrases of A1 as branches of A1 in a tree structure.

To simplify the discussion, we separated the functions of the system into modules, and then discussed each of them individually. Of course, in implementing the present disclosure, one can merge the functions of the different modules into one or more software and/or hardware.

Based on the implementation methods described above, someone ordinarily skilled in the art can implement the disclosed techniques by means of software supported by appropriate hardware platform. Based on this understanding, the essence of the proposed techniques or their contributions to current technologies can be realized in the form of software products. This computer software product can be saved in computer-readable media such as ROM/RAM, floppy disks, CD, and also on one or more instructional computer workstations (which can be a personal computer, server, or network installations etc.), to carry out some or all of the methods described in the present disclosure.

The present disclosure describes different exemplary implementations in a progressive manner, where the similarities of each sample are seen, and the main points in each sample implementation are different from the others. When it comes to installation (system) examples, since the basic characteristics are the same as the implementing method examples, the descriptions are simpler, and one can see the similarities in the sections discussing the implementation of the methods. The above-mentioned installation (system) examples are only for illustration purpose. The different modules that are separately discussed can be physically or not physically separate; the parts of the module can be a physical or non-physical unit. They can be located in one place, or can be distributed in different networks. Based on actual requirements, one can choose some parts of the module or all of it to achieve the purpose of the sample implementation case. A person of ordinary skill in the art will be able to understand and implement the disclosed techniques without exerting additional creativity.

The disclosed techniques can be used in many commonly-used or specialized computer system environment or deployment scenarios, such as, for example, personal computer, computer server, handheld devices or portable devices, flat-type devices, multi-processing systems, micro-processing systems, set-top boxes, programmable consumer electronics devices, network PC, small-scale computers, large-scale computers, including the distributed computing environment of any system or devices mentioned above.

The disclosed techniques can be implemented in executable computer instructions as mentioned in this context, such as procedural modules. In general, a procedural module executes specific tasks or implements routines, procedures, objects, components and data structures of specific abstract data types. The disclosed techniques can also be implemented in a distributed computing environment, where the tasks can be executed using remote handling devices that are connected via communication networks. In a distributed computing environment, the procedural module can be located in the storage medium of a local or remote computer (which contains a storage device).

The present disclosure contains detailed implementation methods related to the disclosed techniques. It is important to note that, a person of ordinary skill in the art, under the premise that there is no deviation from the principles, further improvements and embellishment can be made, and these improvements and embellishments shall be considered as falling within the scope of the present disclosure.

What is claimed is:

1. A method for generating search results, the method comprising:
receiving, by an information search system, a keyword for search;
conducting a search using the keyword to obtain words and phrases related to the keyword;
displaying information corresponding to the keyword in a first section of a webpage;
displaying the keyword and at least one word or phrase related to the keyword in a second section of the webpage; and
after one of the words and phrases related to the keyword is selected, displaying information corresponding to the selected word or phrase in the first section of the webpage while maintaining information displayed in the second section of the webpage.

2. The method of claim 1, further comprising:
highlighting the keyword in the second section of the webpage.

3. The method of claim 1, further comprising:
highlighting the selected word or phrase in the second section of the webpage after the selected word or phrase is selected.

4. The method of claim 1, further comprising:
displaying the keyword and the words and phrases that are related to the keyword and obtained from the search.

5. The method of claim 1, further comprising:
displaying the keyword and the words and phrases related to the keyword in a tree structure, the words and phrases related to the keyword being braches off of the keyword in the tree structure.

6. The method of claim 1, wherein displaying the keyword and at least one word or phrase related to the keyword in a second section of the webpage comprises:
displaying the keyword in the second section of the webpage;
when the keyword displayed in the second section is selected, performing computation to obtain words and phrases related to the keyword; and
displaying in the second section the keyword and at least one of the retrieved words and phrases in a tree structure.

7. The method of claim 1, wherein, after one of the words and phrases related to the keyword is selected, the method further comprises:
performing computation to obtain words and phrases related to the selected word or phrase; and
displaying in the second section at least one of the words and phrases related to the selected word or phrase.

8. The method of claim 7, wherein displaying in the second section at least one of the words and phrases related to the selected word or phrase comprises:
creating a menu of the selected word or phrase, the menu displaying the at least one of the words and phrases related to the selected word or phrase.

9. The method of claim 7, wherein displaying in the second section at least one of the words and phrases related to the selected word or phrase comprises:
displaying the selected word or phrase and the words and phrases related to the selected word or phrase in a tree structure, the words and phrases related to the selected word or phrase being branches off of the selected word or phrase in the tree structure.

10. The method of claim 1, wherein the selected word or phrase is an expanded related word or phrase of the keyword, and wherein the information corresponding to the selected word or phrase is a subset of the information corresponding to the keyword.

11. An information search system, comprising:
a search module that receives a keyword for search and conducts a search using the keyword to obtain words and phrases related to the keyword;
a first section processing module that displays information corresponding to the keyword in a first section of a webpage, the first section processing module displaying in the first section a word or phrase that is related to the keyword and selected by a user; and
a second section processing module that displays the keyword and at least one word or phrase related to the keyword in a second section of the webpage, the second section processing module maintaining information displayed in the second section after the selected word or phrase is selected by the user.

12. The information search system of claim 11, wherein the second section processing module displays the keyword and the words and phrases that are related to the keyword and obtained from the search.

13. The information search system of claim 11, wherein the second section processing module displays the keyword and the words and phrases related to the keyword in a tree structure, the words and phrases related to the keyword being braches off of the keyword in the tree structure.

14. The information search system of claim 13, the second section processing module comprising:
a keyword display sub-module that displays the keyword in the second section of the webpage;
a first related words and phrases computation sub-module that performs computation to obtain words and phrases related to the keyword when the keyword displayed in the second section is selected; and
a first related words and phrases display sub-module that displays in a tree structure the keyword and at least one word or phrase related to the keyword, the at least one word or phrase related to the keyword branching off of the keyword in the tree structure.

15. The information search system of claim 14, the second section processing module further comprising:
a second related words and phrases computation sub-module that performs computation to obtain words and phrases related to the selected word or phrase when the selected word or phrase is selected; and
a second related words and phrases display sub-module that displays in the second section of the webpage at least one word or phrase related to the selected word or phrase.

16. The information search system of claim 15, wherein the second related words and phrases display sub-module creates an expandable menu for the selected word or phrase and displays at least one word or phrase related to the selected word or phrase in the expandable menu.

17. The information search system of claim 15, wherein the second related words and phrases display sub-module displays the selected word or phrase and the words and phrases related to the selected word or phrase in a tree structure, the words and phrases related to the selected word or phrase being branches off of the selected word or phrase in the tree structure.

18. The information search system of claim 11, wherein the selected word or phrase is an expanded related word or phrase of the keyword, and wherein the information corresponding to the selected word or phrase is a subset of the information corresponding to the keyword.
